(19) United States
(12) Patent Application Publication
(10) Pub. No.: US 2006/0057366 A1
(43) Pub. Date: Mar. 16, 2006

(54) Poly(meth) acrylate-based pressure-sensitive adhesive

(76) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/533,831

(22) PCT Filed: Nov. 11, 2003
(86) PCT No.: PCT/EP03/12546

§ 371 Date: Nov. 10, 2005

(30) Foreign Application Priority Data
Dec. 4, 2002 (DE) 10256511.2

(51) Int. Cl. B32B 7/12; B32B 33/00

(52) U.S. Cl. 428/343; 428/41.8

(57) ABSTRACT

Poly(meth)acrylate pressure-sensitive adhesives comprising 15% to 40% by weight of isobornyl acrylate units, having a uniform bond strength over a wide peel-rate range.

The invention relates to poly(meth)acrylate-based pressure-sensitive adhesives which exhibit a uniform bond strength over a wide peel-rate range and to their use as pressure-sensitive adhesive tapes.

For industrial applications the use of acrylate pressure-sensitive adhesive tapes is very common. This is true in particular of adhesive bonds which are performed within a wide temperature range or where solvent resistance is required, where the pressure-sensitive adhesive is to be transparent and, ultimately, the pressure-sensitive adhesive is also not to age under oxygen or ozone and hence is to be stable to weathering.

For these applications, acrylate pressure-sensitive adhesives have become established. A disadvantage of these pressure-sensitive adhesives is that polyacrylates as a general rule are relatively polar (owing to the multiplicity of ester moieties) and therefore develop polar interactions with the substrate. As a result there is an increase, over time, in the bond strength, and the pressure-sensitive adhesive tape is difficult to remove. A further negative property is the difficulty of detaching acrylate pressure-sensitive adhesives particularly at high peel rates. As the peel rate goes up there is likewise an increase in the force required to detach the acrylate pressure-sensitive adhesive tape from the substrate. These properties are unwanted, since there are a large number of applications where, after a certain bonding time, the pressure-sensitive adhesive tape is removed again, and this operation is generally performed by hand. Furthermore, this detachment operation should proceed very quickly and efficiently; in other words, the wish of the user is to remove the pressure-sensitive adhesive tape in a very short time and to expend as little work effort as possible on doing so. Ultimately there should be no residues remaining on the bonded substrate, since any such residues would need to be removed, in turn involving effort.

Pressure-sensitive adhesives (PSAs) have been investigated but little to date in respect of a variable peel rate.

In U.S. Pat. No. 4,339,485 the peel rate was varied for the purpose of investigating the release material.

U.S. Pat. No. 5,925,456 is an exemplar for the measurement of an acrylate PSA at a constant peel rate.

In U.S. Pat. No. 4,358,494, in contrast, polyacrylate PSA tapes were unwound at different peel rates. Here it was confirmed that the force for unwinding these PSA tapes depends heavily on the peel rate.

Accordingly there is a need for an acrylate pressure-sensitive adhesive which can be removed without residue from the substrate and possesses a uniform instantaneous bond strength over a wide peel-rate range.

Surprisingly, and unforeseeably for the skilled worker, this object is achieved by the pressure-sensitive adhesives of the invention, as set out in the main claim and in the dependent claims.

The invention accordingly provides a polyacrylate-based pressure-sensitive adhesive comprising a polymer containing 15% to 40% by weight of isobornyl acrylate units, based on the monomer mixture. The pressure-sensitive adhesive prepared therefrom possesses a bond strength (in the sense of instantaneous bond strength; peel angle 180°, cf. test A) in a tolerance range of ±15% in a peel-rate rate range of 0.1 cm/minute to 100 m/minute; in other words, a releasable adhesive bond produced using this pressure-sensitive adhesive, on steel for example, can be parted again with a consistent application of force, largely independent of the peel rate.

The pressure-sensitive adhesive preferably comprises a polymer formed from a monomer mixture comprising at least the following components: a) 60% to 85% by weight (based on the monomer mixture) of acrylic and/or methacrylic esters having the following formula CH₂═C(R₁)(COOR₂), where R₁═H or CH₃ and R₂ is a linear or branched alkyl radical having 1 to 14 carbon atoms, and b) 10% to 40%, preferably 15% to 40% by weight (based on the monomer mixture) of isobornyl acrylate.

The amounts in percent by weight are based on this base mixture. There may be further components, in which case the weight fractions relative to the overall weight are displaced accordingly. The minimum amount of isobornyl acrylate should be, as apparent from the examples relating to this invention, well above 5% by weight, in order to be able to achieve an evening-out of the peel forces over the rate. In any specific case, however, a rational lower limit can be tried out on the specific application.

For monomers within the meaning of component a) it is very preferred to use acrylic monomers which comprise acrylic and methacrylic esters having alkyl groups consisting of 4 to 14 carbon atoms, preferably 4 to 9 carbon atoms. Specific examples, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate and their branched isomers, such as 2-ethylhexyl acrylate or isooctyl acrylate, for example. Further classes of compound for use, which can likewise be added, preferably in small amounts, under a), are, for example, the corresponding methacrylates.

In one preferred embodiment of the pressure-sensitive adhesive of the invention up to 30% by weight of olefinically unsaturated monomers containing functional groups is added to the monomer mixture as component c).

Monomers used for component c) are vinyl esters, vinyl ethers, vinyl halides, vinlidene halides, and vinyl compounds with aromatic rings and heterocycles in α position. Here again, mention may be made nonexclusively of some examples: vinyl acetate, vinylformamide, vinylpyridine, ethyl vinyl ether, vinyl chloride, vinylidene chloride and acrylonitrile. In a further very preferred procedure the monomers used for component c) include monomers having the following functional groups: hydroxyl, carboxyl, epoxy, acid amide, isocyanato or amino groups.

In a further advantageous version acrylic monomers corresponding to the general formula below are used for component c) 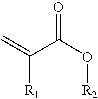
where R₁═H or CH₃ and the radical —OR₂ constitutes or comprises the functional group of the pressure-sensitive adhesive and, for example, in one particularly preferred version, possesses an H-donor action, which facilitates UV crosslinking.

Particularly preferred examples of component c) are hydroxyethyl acrylate, hydroxypropyl acrylate, hydroxylethyl methacrylate, hydroxypropyl methacrylate, allyl alcohol, maleic anhydride, itaconic anhydride, itaconic acid, acrylamide and glyceridyl methacrylate, benzyl acrylate, benzyl methacrylate, phenyl acrylate, phenyl methacrylate, t-butylphenyl acrylate, t-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate, cyanoethyl methacrylate, cyanoethyl acrylate, glyceryl methacrylate, 6-hydroxyhexyl methacrylate, N-tert-butylacrylamide, N-methylolmethacrylamide, N-(buthoxymethyl)methacrylamide, N-methylolacrylamide, N-(ethoxymethyl)acrylamide, N-isopropylacrylamide, vinylacetic acid, tetrahydrofurfuryl acrylate, β-acrylolyloxypropionic acid, trichloroacrylic acid, fumaric acid, crotonic acid, aconitic acid and dimethylacrylic acid, this enumeration not being conclusive.

In a further preferred embodiment of the pressure-sensitive adhesive of the invention use is made for component c) of aromatic vinyl compounds, where preferably the aromatic nuclei consist of C₄ to C₁₈ units and can also contain heteroatoms. Particularly preferred examples are styrene, 4-vinylpyridine, N-vinylphthalimide, methylstyrene, 3,4-dimethoxystyrene and 4-vinylbenzoic acid.

For the polymerization the monomers are chosen such that the resulting polymers can be used as heat-activable PSAs, and in particular such that the resultant polymers possess pressure-sensitive adhesion properties in accordance with the “Handbook of Pressure Sensitive Adhesive Technology” by Donatas Satas (van Nostrand, New York 1989). For these applications the static glass transition temperature of the resultant polymer is advantageously above 30° C.

In order to obtain a polymer glass transition temperature T_{g,A} of ≧30° C., in accordance with the above remarks, the monomers are very preferably selected, and the quantitative composition of the monomer mixture advantageously chosen, in such a way as to give the desired T_{g,A} value for the polymer in accordance with the Fox equation (E1) (cf. T. G. Fox, Bull. Am. Phys. Soc. 1 (1956) 123).

$$\frac{1}{{T}_{g}} = {\sum }_{n} \frac{{W}_{n}}{{T}_{g , n}} \qquad ( E1 )$$

In this equation, n represents the serial number of the monomers used, wₙ the mass fraction of the respective monomer n (in % by weight), and T_{g,n} the respective glass transition temperature of the homopolymer of each of the monomers n, in K.

In order to prepare the polyacrylate PSAs, conventional free-radical polymerizations or controlled free-radical polymerizations will be carried out. For the polymerizations proceeding by a radical mechanism it is preferred to use initiator systems which additionally comprise further free-radical initiators for the polymerization, especially thermally decomposing free-radical-forming azo or peroxo initiators. In principle, however, any customary initiators that are familiar for acrylates are suitable for this purpose. The production of C-centered radicals is described in Houben Weyl, Methoden der Organischen Chemie, Vol. E 19a, pp. 60-147. These methods are preferentially employed analogously.

Examples of radical sources are peroxides, hydroperoxides and azo compounds; some nonexclusive examples of typical radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate and benzpinacol. In one very preferred version the free-radical initiator used is 1,1′-azobis(cyclohexanecarbonitrile) (Vazo 88™ from DuPont).

The average molecular weights Mₙ of the PSAs formed in the controlled free-radical polymerization are chosen such that they are situated within a range from 20 000 and 2 000 000 g/mol. Specifically for further use as hotmelt PSAs, PSAs having average molecular weights Mₙ of from 100 000 to 500 000 g/mol are preferred. The average molecular weight is determined by way of size exclusion chromatography (gel permeation chromatography, SEC or GPC) or matrix-assisted laser desorption/ionization—mass spectrometry (MALDI—MS).

The polymerization may be conducted in bulk, in the presence of one or more organic solvents, in the presence of water, or in mixtures of organic solvents and water. The aim is to minimize the amount of solvent used. Suitable organic solvents or mixtures of solvents are pure alkanes (hexane, heptane, octane, isooctane), aromatic hydrocarbons (benzene, toluene, xylene), esters (ethyl acetate, propyl acetate, butyl acetate or hexyl acetate), halogenated hydrocarbons (chlorobenzene), alkanols (methanol, ethanol, ethylene glycol, ethylene glycol monomethyl ether) and ethers (diethyl ether, dibutyl ether) or mixtures thereof. A water-miscible or hydrophilic cosolvent may be added to the aqueous polymerization reactions in order to ensure that in the course of monomer conversion the reaction mixture is in the form of a homogeneous phase. Cosolvents which can be used with advantage for the present invention are selected from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

Depending on conversion and temperature, the polymerization time amounts to between 4 and 72 hours. The higher the reaction temperature that can be chosen, in other words the higher the thermal stability of the reaction mixture, the lower the reaction time that can be chosen.

For initiating the polymerization the introduction of heat is essential for the thermally decomposing initiators. For the thermally decomposing initiators the polymerization can be initiated by heating at 50-160° C., depending on initiator type.

It may further be of advantage to prepare the polyacrylate PSA by way of an anionic polymerization process. In that case the reaction medium used preferably comprises inert solvents, such as aliphatic and cycloaliphatic hydrocarbons, for example, or else aromatic hydrocarbons.

The living polymer in this case is generally represented by the structure P_{L}(A)-Me, where Me is a metal from group I, such as lithium, sodium or potassium, for example, and P_{L}(A) is a growing polymer block of the monomers A. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium or octyllithium, this enumeration making no claim to completeness. Also known for the polymerization of acrylates, and suitable for use here, are initiators based on samarium complexes (Macromolecules, 1995, 28, 7886).

In addition it is possible to use difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides or alkylaluminum compounds. In one very preferred version the ligands and coinitiators are chosen such that acrylate monomers, such as n-butyl acrylate and 2-ethylhexyl acrylate, for example, can be polymerized directly and do not have to be generated in the polymer by transesterification of the corresponding alcohol.

For the preparation of polyacrylate PSAs having a narrow molecular weight distribution suitability is also possessed by controlled free-radical polymerization methods. In that case it is preferred, for the purpose of the polymerization, to use a control reagent of the general formula:

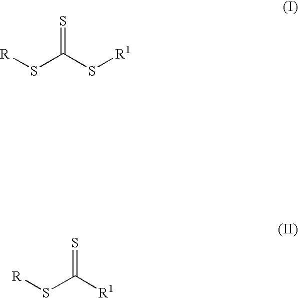

in which

R and R¹, chosen independently of one another or identical, represent
branched and unbranched C₁- to C₁₈ alkyl radicals, C₃- to C₁₈ alkenyl radicals or C₃- to C₁₈ alkynyl radicals;
C₁- to C₁₈ alkoxy radicals;
C₁- to C₁₈ alkyl radicals, C₃- to C₁₈ alkenyl radicals or C₃- to C₁₈ alkynyl radicals that are substituted by at least one OH group or halogen atom or silyl ether;
C₂-C₁₈ heteroalkyl radicals having at least one oxygen atom and/or one NR* group in the carbon chain, where R* can be any (especially organic) radical;
C₁-C₁₈ alkyl radicals, C₃-C₁₈ alkenyl radicals or C₃-C₁₈ alkynyl radicals substituted by at least one ester group, amine group, carbonate group, cyano group, isocyano group and/or epoxide group and/or by sulfur;
C₃-C₁₂ cycloalkyl radicals;
C₆-C₁₈ aryl radicals or benzyl radicals;
hydrogen.

Control reagents of type (I) are composed, preferably, of the following, further-restricted compounds: halogen atoms in this case are preferably F, Cl, Br or I, more preferably Cl and Br. Suitable alkyl, alkenyl and alkynyl radicals in the various substituents include outstandingly not only linear chains but also branched chains.

Examples of alkyl radicals which contain 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl and oleyl.

Examples of alkynyl having 3 to 18 carbon atoms are propynyl, 2-butynyl, 3-butynyl, n-2-octynyl and n-2-octadecynyl.

Examples of hydroxy-substituted alkyl radicals are hydroxypropyl, hydroxybutyl or hydroxyhexyl.

Examples of halogen-substituted alkyl radicals are dichlorobutyl, monobromobutyl or trichlorohexyl.

One suitable C₂-C₁₈ heteroalkyl radical having at least one oxygen atom in the carbon chain is for example —CH₂—CH₂—O—CH₂—CH₃.

Examples of C₃-C₁₂ cycloalkyl radicals include cyclopropyl, cyclopentyl, cyclohexyl or trimethylcyclohexyl.

Examples of C₆-C₁₈ aryl radicals include phenyl, naphthyl, benzyl, 4-tert-butylbenzyl or further substituted phenyl, such as ethyl, toluene, xylene, mesitylene, isopropylbenzene, dichlorobenzene or bromotoluene.

The listings above serve only as examples of the respective groups of compounds, and possess no claim to completeness.

Also suitable for use as control reagents are compounds of the following types 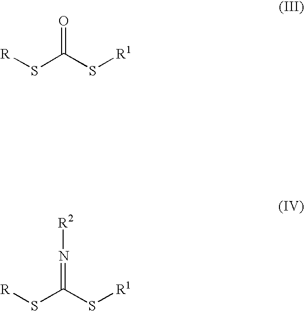
where R² likewise independently of R and R¹ can be chosen from the above-recited group for these radicals.

In the case of the conventional “RAFT process” polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the adhesive performance properties; the residual monomers contaminate the solvent recyclate in the concentration operation; and the corresponding self-adhesive tapes would exhibit very high outgassing. In order to circumvent this drawback of low conversions, the polymerization in one particularly preferred procedure is initiated two or more times.

As a further controlled free-radical polymerization method it is possible to carry out nitroxide-controlled polymerizations. For radical stabilization, in a favorable procedure, use is made of nitroxides of type (Va) or (Vb): 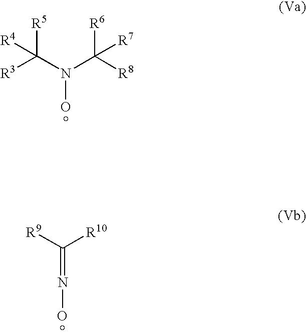
where R³, R⁴, R⁵, R⁶, R⁷, R⁸, R⁹ and R¹⁰ independently of one another denote the following compounds or atoms:
i) halides, such as chlorine, bromine or iodine, for example,
ii) linear, branched, cyclic and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of the (Va) or (Vb) may also be attached to polymer chains of any kind (primarily such that at least one of the abovementioned radicals constitutes a polymer chain of this kind) and may thus be used, for example, as macroradicals or macroregulators for synthesizing the block copolymers.

Controlled regulators become more preferred for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxy pyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1 -piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

U.S. Pat. No. 4,581,429 A discloses a controlled-growth free-radical polymerization process which uses as its initiator a compound of the formula R′R″N—O—Y, in which Y is a free radical species which is able to polymerize unsaturated monomers. The reactions, however, generally have low conversions. A particular problem is the polymerization of acrylates, which proceeds only to very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific radical compounds, such as phosphorus-containing nitroxides based on imidazolidine, for example, are used. WO 98/44008 A1 discloses specific nitroxyls based on morpholines, piperazinones and piperazinediones. DE 199 49 352 A1 describes heterocyclic alkoxyamines as regulators in controlled free-radical polymerizations. Corresponding further developments of the alkoxyamines or of the corresponding free nitroxides improve the efficiency for the preparation of polyacrylates (Hawker, contribution to the National Meeting of the American Chemical Society, Spring 1997; Husemann, contribution to the IUPAC World Polymer Meeting 1998, Gold Coast).

As a further controlled polymerization method it is possible with advantage to synthesize the polyacrylate PSAs using atom transfer radical polymerization (ATRP), in which case preferred initiators used are monofunctional or difunctional secondary or tertiary halides and the halide(s) is (are) abstracted using complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in U.S. Pat. No. 5,945,491 A, U.S. Pat. No. 5,854,364 A and U.S. Pat. No. 5,789,487 A.

For further development it is possible to admix resins to the polyacrylate PSAs. Tackifying resins for addition that can be used include, without exception, all of the tackifier resins that are already known and are described in the literature. Representatives that may be mentioned include pinene resins, indene resins and rosins, their disproportionated, hydrogenated, polymerized and/or esterified derivatives and salts, the aliphatic and aromatic hydrocarbon resins, terpene resins and terpene-phenolic resins and also C5, C9 and other hydrocarbon resins. Any desired combinations of these and further resins may be used in order to adjust the properties of the resultant adhesive in accordance with what is desired. Generally speaking it is possible to use any resins which are compatible with (soluble in) the corresponding polyacrylate, reference being made in particular to all aliphatic, aromatic and alkylaromatic hydrocarbon resins, hydrocarbon resins based on single monomers, hydrogenated hydrocarbon resins, functional hydrocarbon resins, and natural resins. Express reference is made to the depiction of the state of the art in the “Handbook of Pressure Sensitive Adhesive Technology” by Donatas Satas (van Nostrand, 1989).

Additionally it is possible optionally to add plasticizers, fillers (e.g., fibers, carbon black, zinc oxide, titanium dioxide, chalk, solid or hollow glass spheres, microspheres of other materials, silica, silicates), nucleators, expandants, compounding agents and/or aging inhibitors, in the form for example of primary and secondary antioxidants or in the form of light stabilizers.

The polyacrylates prepared preferably by one of the processes outlined above are advantageously subsequently crosslinked, with particular preference being given to the use of thermal crosslinkers, which react under temperature exposure.

Examples of suitable crosslinkers include metal chelates, polyfunctional isocyanates and polyfunctional amines. For the case of additional crosslinking via a free-radical mechanism it is also possible with advantage to use polyfunctional acrylates as crosslinkers.

Examples of suitable thermal crosslinkers include aluminum(III) acetylacetonate, titanium(IV) acetylacetonate or iron(III) acetylacetonate. It is, however, also possible to use, for example, the corresponding zirconium compounds for crosslinking. Besides the acetylacetonates, suitability is likewise possessed by the corresponding metal alkoxides, such as titanium(IV) n-butoxide or titanium(IV) isopropoxide, for example.

For thermal crosslinking it is also possible likewise to use polyfunctional isocyanates, in which case reference may be made here in particular to isocyanates from the company Bayer having the trade name Desmodur™. Further possible crosslinkers include polyfunctional epoxides, aziridines, oxazolidines or carbodiimides.

Prior to crosslinking, the polyacrylates are advantageously applied to a carrier. Coating takes place from solution or from the melt onto the carrier material. For application from the melt, the solvent is preferably stripped off under reduced pressure in a concentrating extruder, in which case use may be made, for example, of single-screw or twin-screw extruders, which advantageously distill off the solvent in different or equal vacuum stages and which possess a feed preheater. The polyacrylate is then crosslinked on the carrier.

Carrier materials used for the PSA, for PSA tapes for example, are the materials that are customary and familiar to the skilled worker, such as films (polyesters, PET, PE, PP, BOPP, PVC), nonwovens, foams, woven fabrics and woven films, and also release paper (glassine, HDPE, LDPE). This enumeration is not conclusive.

For optional crosslinking with UV light it is possible to add UV-absorbing photoinitiators to the polyacrylate PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted ketols, such as 2-methoxy-2-hydroxypropiophenone, aromatic sulfonyl chlorides, such as 2-naphthylsulfonyl chloride, and photoactive oximes, such as 1-phenyl-1,2-propanedione 2-(O-ethoxycarbonyl)oxime, for example.

The abovementioned photoinitiators and others which can be used, and others of the Norrish I or Norrish II type, may contain the following radicals: benzophenone-, acetophenone-, benzo-, benzoin-, hydroxylalkylphenone-, phenyl cyclohexyl ketone-, anthraquinone-, trimethylbenzylphosphine oxide-, methylthiophenyl morpholine ketone-, amino ketone-, azo benzoin-, thioxanthone-, hexarylbisimidazole-, triazine-, or fluorenone, it being possible for each of these radicals to be further substituted by one or more halogen atoms and/or one or more alkyloxy groups and/or one or more amino groups or hydroxyl groups. A representative overview is given by Fouassier: “Photoinitiation, photopolymerization and photocuring: Fundamentals and applications”, Hanser-Verlag Munich 1995. Supplementarily it is possible to employ Carroy et al. in “Chemistry and Technology of UV and EB Formulation for Coatings, Inks and Paints”, Oldring (ed.), 1994, SITA, London.

It is further possible to crosslink the polyacrylate PSA using electron beams. Typical irradiation equipment which may be employed includes linear cathode systems, scanner systems and segmented cathode systems, where the equipment in question comprises electron beam accelerators. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 to 150 kGy, in particular between 20 and 100 kGy.

Finally the invention provides for the use of the above-described PSAs and/or of the PSAs prepared as described above for a single-sided or double-sided adhesive tape composed of at least one carrier and a layer of a pressure-sensitive adhesive.

One advantageous use consists in an adhesive tape which possesses a multilayer product structure, at least one of the layers being composed of an inventive PSA and having a thickness of preferably at least 5 μm, more preferably at least 10 mm.

Carrier materials which can be used to particularly good effect for PSA tapes of this kind are the carrier materials already described above.

The polyacrylate PSA of the invention can be removed without residue and without destruction from the substrate, so that adhesive tapes thus furnished, in particular, can be bonded reversibly to a variety of substrates.

Particular preference is given to bonding to sensitive surfaces which may be easily damaged or which are easily deformed, such as automotive finishes, for example.

The applications for such PSA tapes are very diverse. In particularly preferred versions the PSAs of the invention are used in PSA tapes for which the carrier material takes on a short-term protective function; that is, the substrate is protected against external factors, such as water, acid, base, heat, oil, gasoline, diesel, other liquids, paint, etc. After fulfilling the protective function the PSA tape is removed again. Particular preference is given for this application to the use of single-sided PSA tapes.

In a further preferred version the PSAs of the invention are used in PSA tapes which serve for temporary adhesive bonding of adherends. A very wide variety of materials may be bonded here, such as glass, paper, plastics, metals, nonwovens, woven fabrics, textiles and wood, for example. In one particularly preferred version the adherends are removed from one another again after a certain period of time. For these applications it is particularly preferred to use double-sided adhesive tapes, which in one very preferred version are constructed from at least three layers, the PSA of the invention representing at least the top face or bottom face of the PSA tape and the middle layer constituting the carrier layer.

In addition the PSAs of the invention may also be used for transfer tapes. In the case of this exemplary embodiment the PSA of the invention is coated onto a release film or release paper, so that, after the transfer tape has been applied, the carrier can be peeled from the adhesive film and only the PSA layer is left on the bond site. The pure film of PSA tape is used, for example, for the temporary bonding of adherends. In this case the adherends can be separated from one another easily even at high speeds. Similarly, the single-sided PSA tapes of the invention can also be removed easily from the substrate at high peel rates.

### EXAMPLES

Test Methods

A1-A3. Bond Strength

The peel strength (bond strength) was tested in accordance with PSTC-1. A pressure-sensitive adhesive layer is applied at 50 g/m² to a PET film 25 μm thick. A strip of this specimen 2 cm wide is bonded to a steel plate by being rolled over back and forth three times using a 2 kg roller. The plate is clamped and the self-adhesive strip is peeled off from its free end on a tensile testing machine under a peel angle of 180° and at a rate of 0.1 cm/min (test A1) or 1 m/min (test A2) or 100 m/min (test 3).

B. Peel Increase

A pressure-sensitive adhesive layer is applied at 50 g² to a PET film 25 μm thick.

A strip of this specimen 2 cm wide is bonded to a steel plate by being rolled over back and forth three times using a 2 kg roller. After 96-hour bonding at room temperature (23° C.), atmospheric pressure and 50% humidity the plate is clamped and the self-adhesive strip is peeled off from its free end on a tensile testing machine under a peel angle of 180° and at a rate of 1 m/min.

C. Gel Permeation Chromatography GPC

The average molecular weight Mₙ and polydispersity PD were determined by gel permeation chromatography. The eluent used was THF containing 0.1% by volume trifluoroacetic acid. Measurement took place at 25° C. The precolumn used was PSS-SDV, 5μ, 10₃ Å, ID 8.0 mm×50 mm. Separation was carried out using the columns PSS-SDV, 5μ, 10⁵ and also 10⁵ and 10⁶ each with ID 8.0 mm×300 mm. The sample concentration was 4 g/l, the flow rate 1.0 ml per minute. Measurement was made against PMMA standards.

Test-Specimen Production

### Example 1

A 2 l glass reactor conventional for free-radical polymerizations was charged with 8 g of acrylic acid, 272 g of 2-ethylhexyl acrylate, 120 g of isobornyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox 16™, Akzo Nobel) in solution in 10 g of acetone was added. After 6 hours the batch was diluted with 100 g of special-boiling-point spirit 60/95. After a reaction time of 7 hours, 0.8 g of bis(4-tert-butylcyclohexanyl)peroxydicarbonate peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.6% by weight of aluminum(IIII) acetylacetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

### Example 2

A 2 l glass reactor conventional for free-radical polymerizations was charged with 8 g of acrylic acid, 312 g of 2-ethylhexyl acrylate, 80 g of isobornyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox 16™, Akzo Nobel) in solution in 10 g of acetone was added. After 6 hours the batch was diluted with 100 g of special-boiling-point spirit 60/95. After a reaction time of 7 hours, 0.8 g of bis(4-tert-butylcyclohexanyl)peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.6% by weight of aluminum(III) acetylacetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

### Example 3

A 2 l glass reactor conventional for free-radical polymerizations was charged with 8 g of acrylic acid, 332 g of 2-ethylhexyl acrylate, 60 g of isobornyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox 16™, Akzo Nobel) in solution in 10 g of acetone was added. After 6 hours the batch was diluted with 100 g of special-boiling-point spirit 60/95. After a reaction time of 7 hours, 0.8 g of bis(4-tert-butylcyclohexanyl)peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.6% by weight of aluminum(III) acetylacetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

### Example 4

A 2 l glass reactor conventional for free-radical polymerizations was charged with 8 g of acrylic acid, 252 g of 2-ethylhexyl acrylate, 140 g of isobornyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox 16™, Akzo Nobel) in solution in 10 g of acetone was added. After 6 hours the batch was diluted with 100 g of special-boiling-point spirit 60/95. After a reaction time of 7 hours, 0.8 g of bis(4-tert-butylcyclohexanyl)peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.6% by weight of aluminum(III) acetylacetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

### Reference Example R1

A 2 l glass reactor conventional for free-radical polymerizations was charged with 8 g of acrylic acid, 372 g of 2-ethylhexyl acrylate, 20 g of isobornyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox 16™, Akzo Nobel) in solution in 10 g of acetone was added. After 6 hours the batch was diluted with 100 g of special-boiling-point spirit 60/95. After a reaction time of 7 hours, 0.8 g of bis(4-tert-butylcyclohexanyl)peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.6% by weight of aluminum(III) acetylacetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

### Reference Example R2

A 2 l glass reactor conventional for free-radical polymerizations was charged with 4 g of acrylic acid, 4 g of glycidyl methacrylate, 196 g of 2-ethylhexyl acrylate, 196 g of n-butyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 5 hours, 0.8 g of bis(4-tert-butylcyclohexanyl)peroxydicarbonate (Perkadox 16™, Akzo Nobel) in solution in 10 g of acetone was added. After 6 hours the batch was diluted with 100 g of special-boiling-point spirit 60/95. After a reaction time of 7 hours, 0.8 g of bis(4-tert-butylcyclohexanyl)peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.3% by weight of zinc chloride and 0.4% by weight of Desmodur™L 75 (Bayer AG), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A, B and C.

### Reference Example R3

A 2 l glass reactor conventional for free-radical polymerizations was charged with 8 g of acrylic acid, 272 g of 2-ethylhexyl acrylate, 120 g of stearyl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 3 hours, 100 g of special-boiling-point spirit 60/95 were added. After a reaction time of 5 hours, 0.8 g of bis(4-tert-butylcyclohexanyl)peroxydicarbonate (Perkadox 16™, Akzo Nobel) in solution in 100 g of special-boiling-point spirit 60/95 was added. After 6 hours the batch was diluted with 100 g of special-boiling-point spirit 60/95. After a reaction time of 7 hours, 0.8 g of bis(4-tert-butylcyclohexanyl)peroxydicarbonate (Perkadox 16™, Akzo Nobel) in solution in 10 g of acetone was added. After 10 hours the batch was diluted with 150 g of special-boiling-point spirit 60/95. After a reaction time of 24 h the reaction was terminated and the batch cooled to room temperature. Subsequently the polyacrylate was blended with 0.6% by weight of aluminum(III) acetylacetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

### Reference Example R4

A 2 l glass reactor conventional for free-radical polymerizations was charged with 8 g of acrylic acid, 272 g of 2-ethylhexyl acrylate, 120 g of lauryl acrylate and 266 g of acetone: special-boiling-point spirit 60/95 (1:1). After nitrogen gas had been passed through the reactor with stirring for 45 minutes the reactor was heated to 58° C. and 0.2 g of azoisobutyronitrile (AIBN, Vazo 64™, DuPont) in solution in 10 g of acetone was added. Thereafter the external heating bath was heated to 75° C. and the reaction was carried out constantly at this external temperature. After a reaction time of 1 h a further 0.2 g of AIBN in solution in 10 g of acetone was added. After a reaction time of 2 and 3 hours, 100 g of special-boiling-point spirit 60/95 in each case were added. After a reaction time of 5 hours, 0.8 g of bis(4-tert-butylcyclohexanyl)peroxydicarbonate (Perkadox 16™, Akzo Nobel) in solution in 100 g of special-boiling-point spirit 60/95 was added. After a reaction time of 7 hours, 0.8 g of bis(4-tert-butylcyclohexanyl)peroxydicarbonate (Perkadox 16™, Akzo Nobel) in solution in 100 g of special-boiling-point spirit 60/95 was added. After a reaction time of 9 hours, 100 g of special-boiling-point spirit 60/95 were added. After a reaction time of 24 h the reaction was terminated and the batch cooled to room temperature. Subsequently the polyacrylate was blended with 0.6% by weight of aluminum(III) acetyl-acetonate (3% strength solution, acetone), diluted to a solids content of 30% with special-boiling-point spirit 60/95 and then coated from solution onto a PET film. After drying at 120° C. for 30 minutes, the application rate was 50 g/m². The adhesive properties were analyzed by conducting test methods A and B.

Results

Subsequently the adhesive properties of the polymers prepared were investigated. Reference examples R1 to R4 were included, in order here to investigate the influence of the isobornyl acrylate and to test alternative comonomers.

Examples 1 to 4, in contrast, are inventive comonomer compositions. Table 1 summarizes the adhesive data for all of the examples—taking particular account of the peel rate.

TABLE 1

| | BS to steel | BS to steel | BS to steel |
|---|---|---|---|
| | instantaneous^{a} | instantaneous^{b} | instantaneous^{c} |
| | [N/cm] | [N/cm] | [N/cm] |
| Example | Test A1 | Test A2 | Test A2 |
| 1 | 4.8 | 5.0 | 5.0 |
| 2 | 3.6 | 3.9 | 3.7 |
| 3 | 3.2 | 3.5 | 3.1 |
| 4 | 5.2 | 5.6 | 5.2 |
| R1 | 2.4 | 3.0 | 3.5 |
| R2 | 2.1 | 2.5 | 3.1 |
| R3 | 0.8 | 2.0 | 7.5 |
| R4 | 0.9 | 2.5 | 8.2 |

^{a}BS = bond strength to steel at 23° C. and 50% humidity, peel rate 0.1 cm/min.
^{b}BS = bond strength to steel at 23° C. and 50% humidity, peel rate 1 m/min.
^{c}BS = bond strength to steel at 23° C. and 50% humidity, peel rate 100 m/min.

The data listed in table 1 make it clear that the inventive polymers PSAs (examples 1 to 4) exhibit a virtually constant bond strength to steel within a peel-rate range from 0.1 cm/min to 100 m/min.

Here it is apparent that, in particular by adding isobornyl acrylate as a comonomer, highly constant bond strengths can be obtained. Examples 1 to 4 further demonstrate that the bond strength varies only within a range of less than ±15%.

For comparison purposes, reference examples R1 to R4 were investigated analogously. In example R1 isobornyl acrylate was used as a comonomer, but with a fraction of 5%. As a result of lowering the fraction there was a reduction in the constancy in bond strength as a function of the peel rate, and the range of less than ±15% was no longer maintained. With reference example R2 a polyacrylate was investigated that has a different crosslinking mechanism. Crosslinking via glycidyl methacrylate, however, also does not lead to any improvement. Rather, in this case, there is a scatter in the bond strengths as a function of peel rate from 2.1 to 3.1 N/cm.

In reference example R3, stearyl acrylate was used as comonomer. As a result of the substitution of isobornyl acrylate it became apparent that, as the peel rate goes up, there is a drastic increase in the bond strength to steel. With 7.5 N/cm at 100 m/min, the initial value of 0.8 N/cm went up by more than nine times. A similar picture emerges for reference example R4. Substitution by lauryl acrylate also led in turn to a deterioration.

Another factor of great importance for application as a PSA tape with temporary bonding is the peel increase, since a massive increase in the bond strengths would likewise impair the peel increase, even at low peel rates. In table 2 below, therefore, once again, the peel increase of all of the examples was investigated.

TABLE 2

| | BS to steel instantaneous^{a} | BS to steel after 96 h^{b} |
|---|---|---|
| | [N/cm] | [N/cm] |
| Example | Test A2 | Test b |
| 1 | 5.0 | 5.1 |
| 2 | 3.9 | 4.2 |
| 3 | 3.5 | 3.9 |
| 4 | 5.6 | 5.6 |
| R1 | 3.0 | 3.9 |
| R2 | 2.5 | 3.4 |
| R3 | 2.0 | 2.3 |
| R4 | 2.5 | 2.5 |

^{a}BS = bond strength to steel at 23° C. and 50% humidity measured immediately after bonding; peel speed 1 m/min.
^{b}BS = bond strength to steel at 23° C. and 50% humidity after 96 hours of bonding; peel rate 1 m/min.

The bond strengths measured demonstrate the fact that the peel increase of the PSAs of the invention is very small. The limiting example 3, with an increase from 3.5 to 3.9 N/cm, shows the greatest increase. Even the reference examples R3 and R4 show very little, if any, peel increase. Only reference examples R1 and R2 exhibit more marked peel increase.

1. A polyacrylate-based pressure-sensitive adhesive comprising a polymer containing 10% to 40% by weight of isobornyl acrylate units, based on the monomer mixture.

2. The pressure-sensitive adhesive of claim 1, comprising a polymer formed from a monomer mixture comprising components:
a) 60% to 85% by weight, based on the weight of monomer mixture, of acrylic and/or methacrylic esters having the formula CH₂═C(R₁)(COOR₂), where R₁═H or CH₃ and R₂ is a linear or branched alkyl radical having 1 to 14 carbon atoms, and
b) 10% to 40% by weight, based on the weight of monomer mixture of isobornyl acrylate.

3. The pressure-sensitive adhesive of claim 2, wherein said monomer mixture further comprises
c) up to 30% by weight of olefinically unsaturated monomers containing functional groups.

4. The pressure-sensitive adhesive of claim 2, wherein said component a) comprises acrylic and methacrylic esters having alkyl groups which have 4 to 14 carbon atoms.

5. The pressure-sensitive adhesive of claim 1, comprising tackifier resins.

6. The pressure-sensitive adhesive of claim 1, further comprising additives selected from the group consisting of plasticizers, fillers, nucleators, expandants, compounding agents and aging inhibitors.

7. A single-sided or double-sided adhesive tape or transfer tape comprising at least of a carrier and a layer of the pressure-sensitive adhesive of claim 1.

8. The single-sided or double-sided adhesive tape or transfer tape of claim 7. wherein the thickness of said layer of pressure-sensitive adhesive is at least 5 μm.

9. The single-sided or double-sided adhesive tape or transfer tape of claim 7, wherein the carrier is made of a film selected from the group consisting of polyester, PET, PE, PP, BOPP and PVC, or of a nonwoven, foam, woven fabric, or woven film, or of release paper.

10. A method for bonding an adhesive tape to automotive finishes, which comprises bonding an adhesive tape of claim 7 to said automotive finishes.

11. The pressure-sensitive adhesive of claim 2, wherein said component b) is present in an amount of 15% to 40% by weight, based on the weight of monomer mixture.

12. The pressure-sensitive adhesive of claim 4, wherein said alkyl groups have 4 to 9 carbon atoms.

13. The pressure-sensitive adhesive of claim 5, wherein said tackifier resins are compatible with the polymers.

14. The pressure-sensitive adhesive of claim 5, wherein said tackifier resins are present in an amount of up to 40% by weight, based on the weight of pressure-sensitive adhesive.

15. The pressure-sensitive adhesive of claim 14, wherein said tackifier resins are present in an amount of up to 30% by weight, based on the weight of pressure-sensitive adhesive.

16. The single-sided or double-sided adhesive tape or transfer tape of claim 8, wherein said layer of pressure-sensitive adhesive is at least 10 μm thick.
